(19) United States
(12) Patent Application Publication
(10) Pub. No.: US 2017/0278168 A1
(43) Pub. Date: Sep. 28, 2017

(54) ELECTRICAL CONNECTOR PORTS, INTERFACES AND COMPATIBLE PAIRING DATABASE, APPLICATION AND SYSTEM

(71) Applicants: Michael Saigh, Clayton, MO (US); Xiaohong Zhang, Clayton, MO (US)

(72) Inventors: Michael Saigh, Clayton, MO (US); Xiaohong Zhang, Clayton, MO (US)

(21) Appl. No.: 15/082,589

(22) Filed: Mar. 28, 2016

(51) Int. Cl. G06Q 30/06

(52) U.S. Cl. CPC G06Q 30/0625

(57) ABSTRACT

The present invention relates to a system which can accurately scan identify and match a plurality of electronic devices' connectors in order to minimize incompatibility, and interface port-(male-female) pairing problems prior to purchase. In addition, the present invention includes any commercial and retail device kiosk; “Connector Scan and Match” (CSM) and/or mobile application database and system. The CSM system enables users to update connectors, replace connectors or interface new or previously purchased electronic devices with other electronic devices. It is understood by anyone familiar with the art that CSM could include any wired, and or wireless connectors for any electronic device to “pair” connectivity, power and data transfer.

### CROSS-REFERENCE TO RELATED APPLICATIONS

This application claims priority to U.S. provisional application No. 62/140,172, filed on Mar. 30, 2015, which is incorporated herein by reference as though fully set forth herein.

### STATEMENT REGARDING FEDERALLY SPONSORED RESEARCH OR DEVELOPMENT

Not applicable.

### BACKGROUND OF THE INVENTION

The present invention relates to an electronic device, which requires a matching plurality of electrical connection(s) and interfaces.

There are thousand connector (port(s) types which provide power, wide varying in size, voltage, functions, current rating, size, and type of connectors. In addition, a multitude of various connectors used for the transfer of data between a plurality of devices, systems and networks and also vary in size, type of connector, speed of data transfer, type of data and connectors (ports), etc.

Wireless or wired connectors are required when transferring data from one computer to another and/or one mobile device to another, and/or one any combination of devices a of networks. Data could be transferred through network is technically “transmitted” over one network or a plurality of networks or through a cloud network.

It is also understood by anyone familiar with the art that thousands of different types of connectors could be used for thousands of purposes and functions. These connections are in many cases standard connections such as HDMI cables for example and there are thousands of examples where manufactures utilize specialty and unique connections for their devices including data transfer type (audio, video, multimedia, etc.), data transfer speed, bit stream, security (encryption, decryption), data compression, analog to digital, digital to analog, source coding and decoding, Internet speeds, (cable, satellite, radio wave, microwave, infrared, etc.) power (battery), modulation method, multiple standards, protocol layers, design architectures, signals and transmission types, applications, functions and a many other factors and combination(s) of factors. The complex combinations of thousands of permutations of components, functions and uses compound customer confusion when replacing connectors as scene in Table I. or interfacing other device, s or applications as shown in Table II.

TABLE I. Connectors (male/female) either wireless or wired or a combination of both. The following exemplifies various connector types and applications but not limited to Stereo audio speakers extension cables (retractable), HDMI cables, Mobile Cables, Car stereo cable DVD to RCA cables, Video cables, Converters, Head Set Split Adapters, DVI cable HDMI to DVI/mini DVI converter Micro USB, VGA video cables, CAT network cables, PS/2 adapters, Parallel Printer Adapters and/or a combination of one or more of all of the above and other connectors.

TABLE II. Equipment requiring connectors include but not limited to Laptops, Desktops, Printers, Mouse(s), Tablets, Notebooks, Cameras, Scanners, Copiers, Cellular, Wireless Modems, Video Cards, Adaptors, Video Game platforms, wearables, PC Sound cards, Theater Accessories, PC and or mobile displays, Projectors, Phone Security Systems, Webcams, Mobile Devices and/or a combination of all of one or more of the above and other devices.

Commercial (retail), industrial users face a multitude or connector options every time they try to purchase these devices. With the thousands of combinations of connectors required to interface other devices (i.e. adaptors, accessories), replace old connectors (pin-dock breaks) and/or connector cables, increase a devices capabilities and functions and other reasons. It is often the case that consumers often guess at which connectors (male-female) are compatible and when trying the connection after opening the package must return the item. In addition, the present invention includes any commercial and retail device.

At present, there is no systematic approach and system in-place at the retail level to allow employees and individual customers to accurately determine the correct connector (male-female), correct adaptor(s), and the correct connector to new devices and other electrical products. It is understood by anyone familiar with the art that the system could be used for industrial customers and remote customers outside of a physical retail store.

### SUMMARY OF INVENTION

The following summary of the invention is provided and intended to facilitate an understanding of some of the innovative features unique to the invention, and is not intended to be a full description of variations. As previously described, Table I., defines a list of connector acronyms and applications employed throughout this specification as an aid to understanding the described embodiments of the present invention.

The “Connector Scan and Match” (CSM) and/or mobile application database and system, enables users to update connectors, replace connectors or interface new or previously purchased electronic devices with other electronic devices. One iteration of the presented invention could be exemplified by the “Connector Fit and Match” (CFM) system includes but is not limited to:

The CFM system could include a “Connectors Fitting Board” for retail store and home use which allow users to fit their own connectors and match the built-in samples of connectors (female/male) such as for example, a variety of USB interfaces, HDMI cables, VGA adapters and a multitude of other connectors. The CFM system for example could be utilized to identify appropriate connector via the fitting board. The CSM system could download and update connector and other data through one or more databases and Internet servers and sub-servers. In addition, the CSM system could interface retail and online marketplaces in order to compare connector inventories, update the data and software, change pricing if necessary and make-current other related data for new electronic products, software and other applications. It is understood by anyone familiar with the art that the CSM system is secure and only authorizes individuals could access the informational database when programming the system and updating the data.

The “Connector Scan and Match” (CSM) system includes but is not limited to: The CSM system could include camera and or scanner software through a mobile phone or computer application which could match the mobile devices built-in connectors (female/male) such as for example, a variety of USB interfaces, HDMI cables, VGA adapters and a multitude of other connectors. The CSM system for example could utilize and identify an electronic connector through one application which will picture, identify and describe the capacity, functionality and pairing to a plurality of connectors which could be used by the device. For example, the CSM system could enable an online store's database to detect the user's connectors (Table I.) for all types and classifications of electronic devices as shown in Table II. In CSM database will not only could automatically detect the connectors for the user's device but could pair the device accurately recognize “pair” and match the device with any type of compatible connector and interface for all applications required by the user. CSM enable and inform the user of connector incompatibilities, computer processing limitations and needed software updates required prior to the online purchase of the connector and applications as previously described.

In addition, plug-in cords off all types could include and attached RFID identification which will serve to identify the actual electrical connector, the electrical device, compatible electronic connector ports, replacement plugs and retail stores or web locations which supply the electrical connector.

In another exemplified application of the GSM system, a Connector Fitting Kiosk (CFK) for retail stores, in accordance with embodiments of the present invention creates a logical diagram application which could interface the CSM smart phone application and recognition capability as previously described. In another embodiment of the present invention, the kiosk could physically scan a user's connector requiring replacement for instance. The CFK could also list the physical store's matching SKU's, pricing, store location, compatible accessories and other equipment and a host of other product details. The CFK display could also match the user's device hardware model with any type of compatible connector through its search browser. It is understood by anyone familiar with the art that the user CFK kiosk could be wall-mounted, be equipped with transactional credit card or debit card payment applications, bitcoin, printer or be able to read product barcodes.

The CSM Barcode Recognizer and Identifier, in accordance with embodiments of the present invention could allow bricks and mortar retailers and online stores to also match and pair connectors, hardware and software applications when required. For example, CSM could allow users an efficient means of searching one or more databases not only to compare connectors, various interfaces and applications with product availability and pricing.

In yet another embodiment, a physical plug-in CSM kiosk could contain a multiplicity of connectors in one or more categories in order for the customer to abridge the time it takes to try to read and match their connection with the new replacement unit. It is understood by anyone familiar with the art that a physical plug-in kiosk could be equipped with a display and other hardware and software as previously described in the CFK scanning unit.

### BRIEF DESCRIPTION OF THE DRAWINGS

Other aspects, features, and advantages of the present invention will become more fully apparent from the following detailed description, the appended claims, and the accompanying drawings in which like reference numerals identify similar or identical elements.

FIG. 1 shows an example of a Connectors Fitting Board for retail store and home use, in accordance with embodiments of the present invention;

FIG. 2 shows a Connector Fitting Kiosk for retail stores, in accordance with embodiments of the present invention;

FIG. 3 shows a logical diagram of Smart Phone Application with Recognition Capability, in accordance with embodiments of the present invention;

FIG. 4 an exemplary of Barcode Recognizer and Identifier, in accordance with embodiments of the present invention.

### DETAILED DESCRIPTION

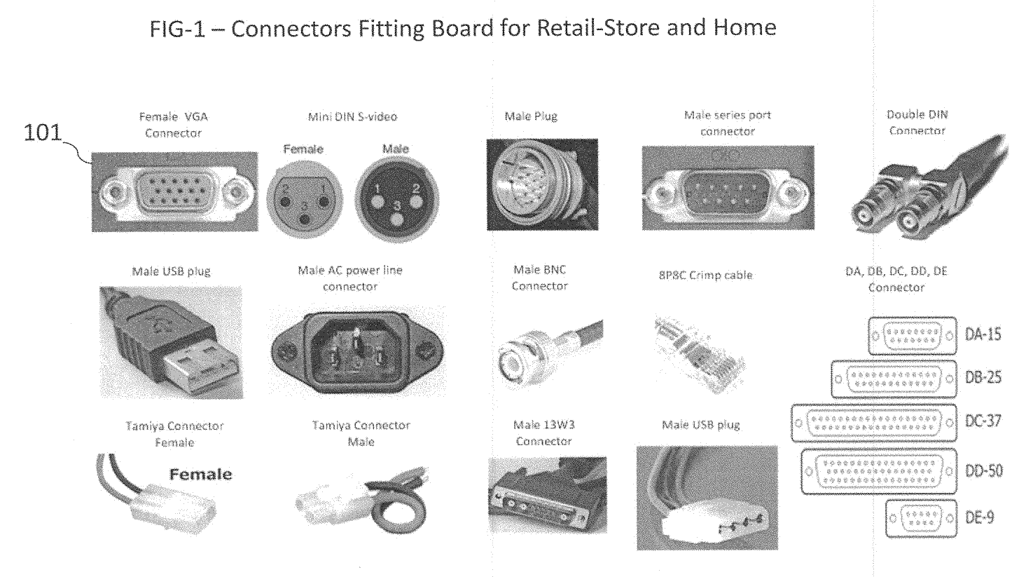

FIG. 1 exemplifies Connectors Fitting Board for retail store and home use, such as 101—Female VGA Connector. The connectors range in usage, size and purpose. The connectors could include one or more (male and female) connectors as exemplified in Table I and Table II and also shown in FIG. 1.

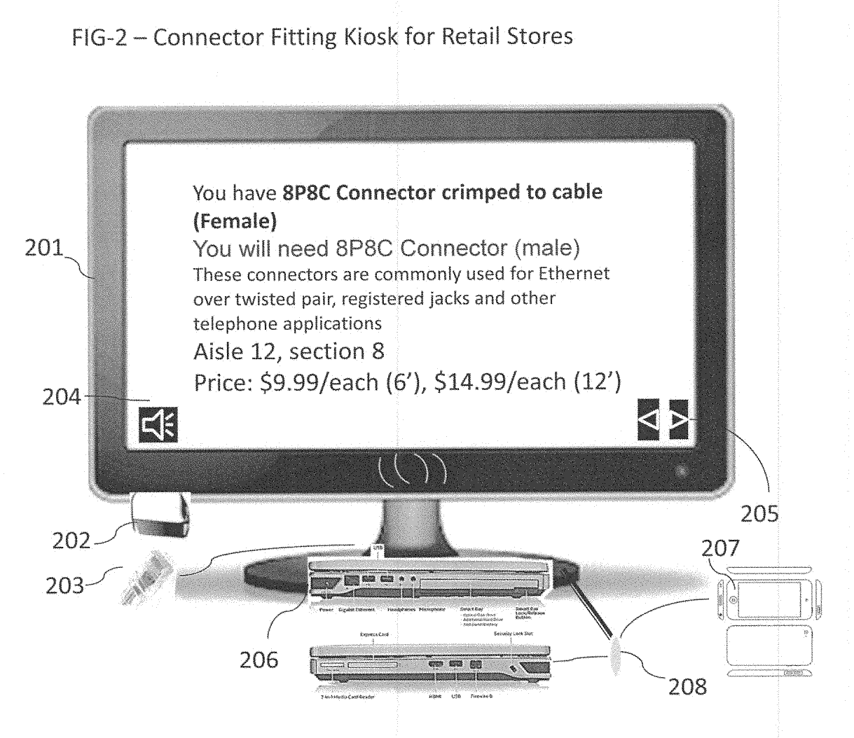

FIG. 2 shows a Connector Fitting Kiosk for retail stores, in accordance with embodiments of the present invention; The Connector Fitting Kiosk, display screen could be of any size, shape and form. The display FIG. 201 could access one or more servers including but not limited to one or more retail stores (online marketplace) database. A customer could insert his or her connector exemplified by a broken connector FIG. 203. FIG. 203 illustrates a customer inserting his or her connector into a CSM scanning chamber exemplified and shown by FIG. 202. It is obvious to anyone skilled with the art that the scanning technology could be 2d, 3d and scan up to 360° and not only scan the connector but match the imagine with a “pairing” image recognition in order to identify not only the connector but the devices model, the interfaces and other compatible products, interfaces, accessories, etc. FIG. 208 is a wand scanner to attachment which could scan a laptop's (FIG. 206) ports (connections), mobiles devices (FIG. 207) ports (connections) or any other devices connectors and interfaces. In addition, the CSM system matches the ports (connectors) with the retail (online stores) inventory and details various connection options and potential new device options, etc. as exemplified by FIG. 201. FIG. 205/FIG. 204 (volume speaker, microphone or headphone) represents various touch screen control options although it is understood by anyone familiar with the art that a mouse, touch screen, voice command or Bluetooth (Wi-Fi) connection link to a smart cellular device could also be used for a similar control purpose. It is also understood by anyone familiar with the art that RFID/barcodes identifiers could be used to categorize and ascertain the devices model and type of connectors or ports.

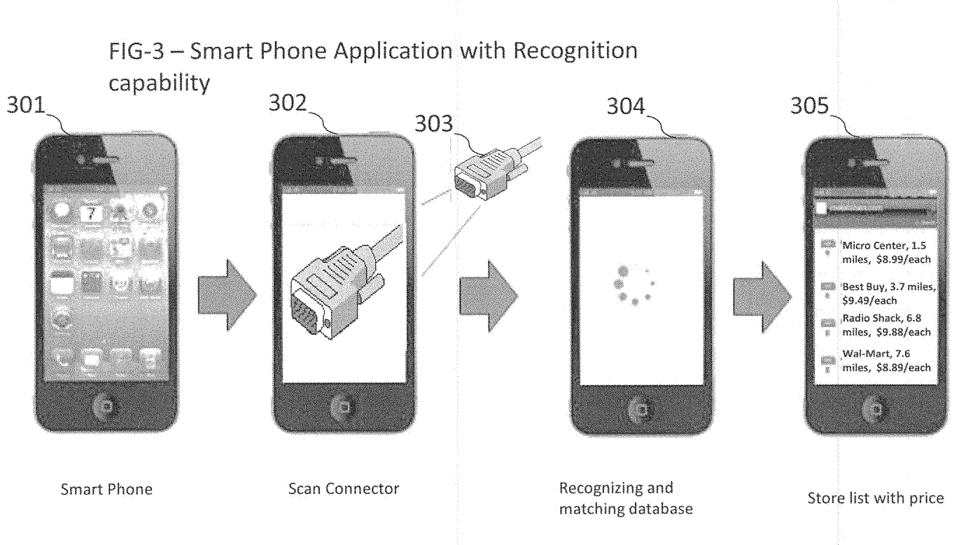

FIG. 3 shows a logical diagram of Smart Phone Application with Recognition Capability, in accordance with embodiments of the present invention; FIG. 301 represents a smartphone application which could both identify various connections, compatibilities, accessories and interfaces. In addition, FIG. 301 could recognize the devices ports and connectors and access an on-line matching database which both matches the connector but assists the CSM user to ascertain other compatible (wireless or wireland) connections, match the requested functions and or new accessories with the user's needs and requirements. In addition, FIG. 305, searches the nearest store inventorying the item(s), prices and other information or compatible products. It is understood by anyone familiar with the art that pricing comparatives, online inventory and remote or and payment technology could be included as a component of the CSM system.

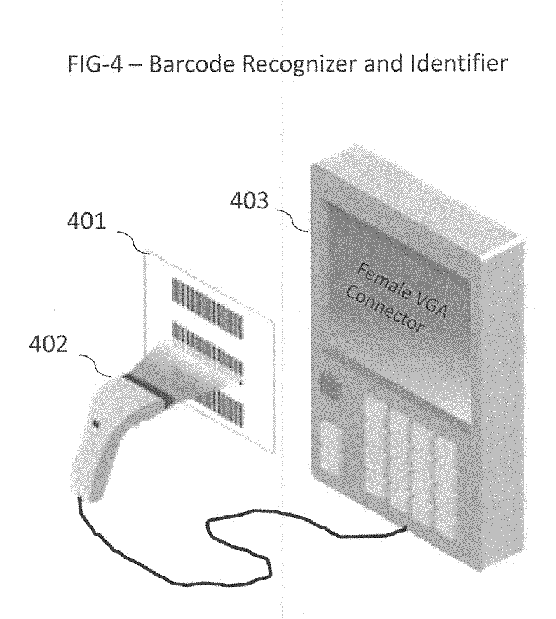

FIG. 4 an exemplary of Barcode Recognizer and Identifier, in accordance with embodiments of the present invention; In addition analogous to FIGS. 1-3, bar codes scanners could assist in assessing both the female port and male connectors within a physical stores, compatible accessories, product data, descriptions and other information.

It should be understood that the steps of the exemplary methods set forth herein are not necessarily required to be performed in the order described, and the order of the steps of such methods should be understood to be merely exemplary. Likewise, additional steps may be included in such methods, and certain steps may be omitted or combined, in methods consistent with various embodiments of the present invention.

As used herein in reference to an element and a standard, the term “compatible” means that the element communicates with other elements in a manner wholly or partially specified by the standard, and would be recognized by other elements as sufficiently capable of communicating with the other elements in the manner specified by the standard. The compatible element does not need to operate internally in a manner specified by the standard.

Also for purposes of this description, the terms “couple,” “coupling,” “coupled” “connect,” “connecting,” or “connected” refer to any manner known in the art or later developed in which energy is allowed to be transferred between two or more elements, and the interposition of one or more additional elements is contemplated, although not required. Conversely, the terms “directly coupled,” “directly connected,” etc., imply the absence of such additional elements. Signals and corresponding nodes or ports may be referred to by the same name and are interchangeable for purposes here.

It will be further understood that various changes in the details, materials, and arrangements of the parts which have been described and illustrated in order to explain the nature of this invention may be made by those skilled in the art without departing from the scope of the invention as expressed in the following claims.

What is claimed is:

1. An electrical connector port network for retailer comprising an attached RFID ID for compatible replacement electrical cords used for and electronic device.

2. The database network of claim 1 wherein one or more secure retail databases could identify configured to identify the electrical connector for replacement.

3. The database network of claim 1 wherein the one or more retail networks can locate the replacement electrical cord for a particular device through ID software.

4. A retail Connector Scanner and Match “CSM” device located at retail stores which inventory electrical connector parts and devices to match the old cord.

5. The retail CSM which could read the electric cord identification for replacement.

6. The retail CSM of claim 5 to provide replacement cords shelf location, cost and device compatibility.
